(19) United States
(12) Patent Application Publication
(10) Pub. No.: US 2026/0027947 A1
(43) Pub. Date: Jan. 29, 2026

(54) HIGH VOLTAGE BATTERY THERMAL RUNAWAY MITIGATION SYSTEM

(71) Applicant: FCA US LLC, Auburn Hills, MI (US)

(72) Inventors: Uday Kiran Mahakali, Auburn Hills, MI (US); Sreekanth Surapaneni, Auburn Hills, MI (US); Venkata Krishna Mohan Chagarlamudi, Auburn Hills, MI (US); Avinash Kumar Jonnalagadda, Auburn Hills, MI (US); Sandeep Makam, Auburn Hills, MI (US)

(21) Appl. No.: 18/786,988

(22) Filed: Jul. 29, 2024

(51) Int. Cl. B60L 58/25; B60L 3/00; H01M 10/42; H01M 10/44; H01M 10/613; H02J 7/00; H02J 7/34

(52) U.S. Cl. CPC B60L 58/25; B60L 3/0046; H01M 10/425; H01M 10/443; H02J 7/00309; H02J 7/342; H02J 7/345; H01M 2010/4271; H01M 10/613; H01M 2220/20; H02J 2207/50

(57) ABSTRACT

An electrified vehicle includes an electric traction motor, a high voltage (HV) battery system including a HV battery pack configured to power the electric traction motor. The HV battery pack includes a plurality of battery modules each configured to store electrical energy, an auxiliary storage device electrically coupled to the battery modules, and one or more switches/relays configured to selectively allow transfer of electrical charge from each battery module to the auxiliary storage device. A battery management system (BMS) includes a controller programmed to detect a thermal runaway event of one or more of the battery modules, and open/close the one or more switches/relays in response to detecting the thermal runaway event to thereby transfer electrical charge from the one or more battery modules experiencing the thermal runaway event to the auxiliary storage device, to thereby slow or prevent a propagation of the thermal runaway.

### FIELD

The present application relates generally to electrified vehicles and, more particularly, to a thermal runaway system for high voltage battery systems of electrified vehicles.

### BACKGROUND

Electrified vehicles include one or more electric motors configured to generate mechanical drive torque using electrical energy (e.g., current) provided by a high voltage battery system. A “thermal runaway” is a potentially problematic situation for a battery system where a self-ignition occurs when there is a sudden release of stored energy in the cell due to some type of internal short circuit. This rapid rise in temperature of one cell can result in a thermal event which can then spread rapidly to adjacent cells. During some thermal runaway events, hot gases coming out of the degassing vents could spread or disperse under the vehicle and pose fire hazard to vehicle occupants. As such, it is important to provide a reasonable time for vehicle to stop and occupants to disembark after the thermal runaway event is triggered. Known thermal runaway mitigation techniques include use of flame-retardant material, particular battery cell chemistry (e.g., lithium iron phosphate), or prismatic cell form factors. However, these techniques may only mitigate flames to a certain degree and lower driving range. Accordingly, while such conventional electrified vehicle battery management techniques do work well for their intended purpose, there exists an opportunity for improvement in the relevant art.

### SUMMARY

In accordance with one example aspect of the invention, an electrified vehicle is provided. In one exemplary implementation, the electrified vehicle includes an electric traction motor, a high voltage (HV) battery system including a HV battery pack configured to power the electric traction motor. The HV battery pack includes a plurality of battery modules each configured to store electrical energy, an auxiliary storage device electrically coupled to the battery modules, and one or more switches/relays configured to selectively allow transfer of electrical charge from each battery module to the auxiliary storage device. A battery management system (BMS) includes a controller programmed to detect a thermal runaway event of one or more of the battery modules, and open/close the one or more switches/relays in response to detecting the thermal runaway event to thereby transfer electrical charge from the one or more battery modules experiencing the thermal runaway event to the auxiliary storage device, to thereby slow or prevent a propagation of the thermal runaway.

In addition to the foregoing, the described electrified vehicle may include one or more of the following features: wherein the controller is further programmed to identify one or more adjacent battery modules adjacent to the one or more battery modules experiencing the thermal runaway event, and subsequently open/close the one or more switches/relays to thereby transfer electrical charge from the one or more adjacent battery modules to the auxiliary storage device, to thereby further slow or prevent a propagation of the thermal runaway; wherein the auxiliary storage device is maintained at 0% state of charge until detection of the thermal runaway event; and wherein the auxiliary storage device is also a battery module.

In addition to the foregoing, the described electrified vehicle may include one or more of the following features: wherein the auxiliary storage device is at least one capacitor; wherein each battery module is separately and electrically connected to the auxiliary storage device by a bus bar and one switch/relay; wherein the one or more switches/relays are controlled by the BMS controller; wherein the one or more switches/relays are temperature sensitive and configured to trigger based on reaching a predetermine temperature threshold; wherein the one or more switches/relays are gas sensitive and configured to trigger based on sensing a combustion product gas; and wherein the controller is further programmed to utilize the electrical charge transferred to the auxiliary storage device to power additional components to mitigate the thermal runaway.

In accordance with one example aspect of the invention, a method of mitigating a thermal runaway event of an electrified vehicle is provided. In one exemplary implementation, the vehicle includes an electric traction motor and a high voltage (HV) battery system including a battery pack that includes a plurality of battery modules, an auxiliary storage device, and one or more switches/relays configured to selectively allow transfer of electrical charge from each battery module to the auxiliary storage device.

In one example, the method includes detecting, by a controller, a thermal runaway event of one or more of the battery modules, and opening/closing the one or more switches/relays in response to detecting the thermal runaway event to thereby transfer electrical charge from the one or more battery modules experiencing the thermal runaway event to the auxiliary storage device, to thereby slow or prevent a propagation of the thermal runaway.

In addition to the foregoing, the described method may include one or more of the following features: identifying, by the controller, one or more adjacent battery modules adjacent to the one or more battery modules experiencing the thermal runaway event; and subsequently opening/closing the one or more switches/relays to thereby transfer electrical charge from the one or more adjacent battery modules to the auxiliary storage device, to thereby further slow or prevent a propagation of the thermal runaway; wherein the auxiliary storage device is maintained at 0% state of charge until detection of the thermal runaway event; wherein the auxiliary storage device is also a battery module; and wherein the auxiliary storage device is at least one capacitor.

In addition to the foregoing, the described method may include one or more of the following features: wherein each battery module is separately and electrically connected to the auxiliary storage device by a bus bar and one switch/relay; wherein the one or more switches/relays are controlled by the controller; wherein the one or more switches/relays are temperature sensitive and configured to trigger based on reaching a predetermine temperature threshold; wherein the one or more switches/relays are gas sensitive and configured to trigger based on sensing a combustion product gas; and utilizing, by the controller, the electrical charge transferred to the auxiliary storage device to power additional components to mitigate the thermal runaway.

Further areas of applicability of the teachings of the present disclosure will become apparent from the detailed description, claims and the drawings provided hereinafter, wherein like reference numerals refer to like features throughout the several views of the drawings. It should be understood that the detailed description, including disclosed embodiments and drawings references therein, are merely exemplary in nature intended for purposes of illustration only and are not intended to limit the scope of the present disclosure, its application or uses. Thus, variations that do not depart from the gist of the present disclosure are intended to be within the scope of the present disclosure.

### BRIEF DESCRIPTION OF THE DRAWINGS

FIG. 1 is a functional block diagram of an example vehicle having a battery management system in accordance with the principles of the present application;

FIG. 2 is a schematic diagram of an example high voltage battery pack of the vehicle shown in FIG. 1, in accordance with the principles of the present application; and

FIG. 3 is a flow diagram of an example method of detecting and mitigating a thermal runaway event of the battery pack shown in FIG. 2, in accordance with the principles of the present application.

### DETAILED DESCRIPTION

As previously discussed, “thermal runaway” refers to the scenario when a battery cell self-ignition causes a thermal event that can rapidly spread to adjacent battery cells and potentially damage the HV battery system and cause thermal propagation outside of the battery system. During such a thermal runaway event, it is important to provide enough time for the vehicle to stop and its passengers to disembark. Accordingly, systems and methods are provided herein configured to detect a thermal runaway event, slow thermal propagation, and thereby increase the amount of time for vehicle passengers to exit the vehicle.

In one example, a control system or battery management system (BMS) is configured to monitor a HV battery pack to detect or forecast a thermal runaway event. Because the intensity or onset of a thermal runaway event is at least in part dependent upon the state of charge (SOC) of the battery cells in the HV battery pack, the system is designed to reduce the SOC of the battery module experiencing the thermal runaway. In this way, the system is configured to transfer as much electrical charge as needed to slow down the propagation of thermal runaway from the faulty battery module once the thermal runaway event is detected or forecasted by the BMS. The transferred electric charge is stored in an auxiliary electrical storage device, such as an on-board capacitor, capacitor bank, auxiliary battery module, combination of capacitor bank and auxiliary battery module, or other suitable storage device.

For example, during a thermal runaway, the system reduces the SOC of the faulty battery module by transferring a portion (e.g., 20%) of the electric charge to the auxiliary storage device to slow down and delay the propagation of thermal runaway from the moment thermal runaway is detected or forecasted by the BMS, thereby providing more time for passengers to exit the vehicle. In another example implementation, the SOC of the battery modules immediately surrounding the faulty battery module is reduced to further mitigate thermal propagation. In both implementations, the SOC of the auxiliary storage device is maintained at 0% SOC to allow for maximum rate of transfer of the electrical energy prior to the thermal runaway event.

In the example embodiment, additional bus bars connect each of the battery modules within the HV battery pack to the auxiliary storage device. Switches/relays are installed on these bus bars near/on/in the battery modules. The switches/relays are normally OFF to block flow of electricity or charge from the battery modules to the auxiliary storage device. The switches/relays may be toggled from OFF to ON in either of two operations. In the first operation, when a thermal runaway is detected, the BMS actively controls the switches of surrounding battery modules which are at maximum risk of continuing thermal propagation. The BMS can prioritize which modules to discharge based on HV battery pack architecture/packaging. In the second operation, the switches/relays include a temperature sensing element (e.g., thermocouple) or a gas sensing element utilized to passively trigger the switch from OFF to ON, based on a calibratable predetermined temperature threshold or sensing a gaseous combustion product.

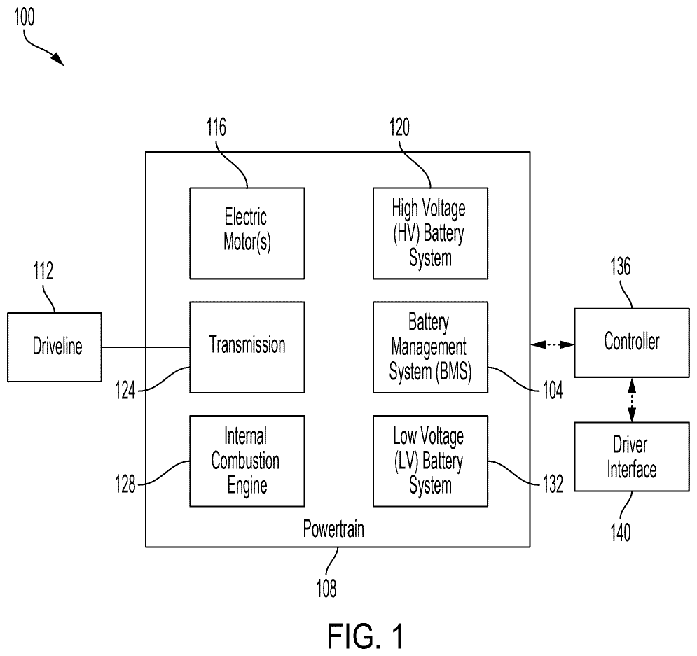

With initial reference to FIG. 1, a functional block diagram of an electrified vehicle 100 having an example BMS 104 according to the principles of the present application is illustrated. The electrified vehicle 100 could be any suitable type of electrified vehicle, including, but not limited to, a battery electric vehicle (BEV) and a plug-in hybrid electric vehicle (PHEV). The electrified vehicle 100 comprises an electrified powertrain 108 configured to generate and transfer drive torque to a driveline 112 for vehicle propulsion. The electrified powertrain 108 includes one or more electric traction motors 116 each configured to generate mechanical drive torque using energy (e.g., electrical current) supplied by a high voltage battery system 120. For example, an inverter (not shown) could be used to convert the direct current (DC) from the high voltage battery system 120 to three-phase alternating current (AC) to power the electric traction motor(s) 116. A transmission 124 (e.g., an automatic transmission) is configured to transfer the drive torque from the electrified powertrain 108 to the driveline 112.

The electrified powertrain 108 also includes an optional internal combustion engine 128 configured to combust a mixture of air and fuel (gasoline, diesel, etc.) to generate mechanical torque for vehicle propulsion and/or conversion to electrical energy, such as for battery system recharging. A low voltage battery system 132 (e.g., a 12-volt (V) battery) is configured to power low voltage components and accessory loads of the electrified vehicle 100. A controller 136 is configured to control the electrified powertrain 108, including controlling the electrified powertrain to generate an amount of drive torque to satisfy a torque request provided by a driver/operator via a driver interface 140 (e.g., an accelerator pedal).

The BMS 104 is a collection of hardware and software that continuously monitors the temperature and operating parameters of the HV battery system 120 and operates in conjunction with vehicle systems to allow the HV battery to operate safely and efficiently. The BMS 104 is configured to forecast or detect occurrence of thermal runaway by monitoring parameters such battery cell or battery module voltage and temperature. The BMS 104 could be part of or integrated with the controller 136 or could be its own separate or standalone system (e.g., with its own controller, such as a traction battery management unit (TBMU)). The operation of the BMS 104 for thermal runaway event detection and mitigation and some examples of its circuit configurations per some implementations of the present application will now be shown and described in greater detail.

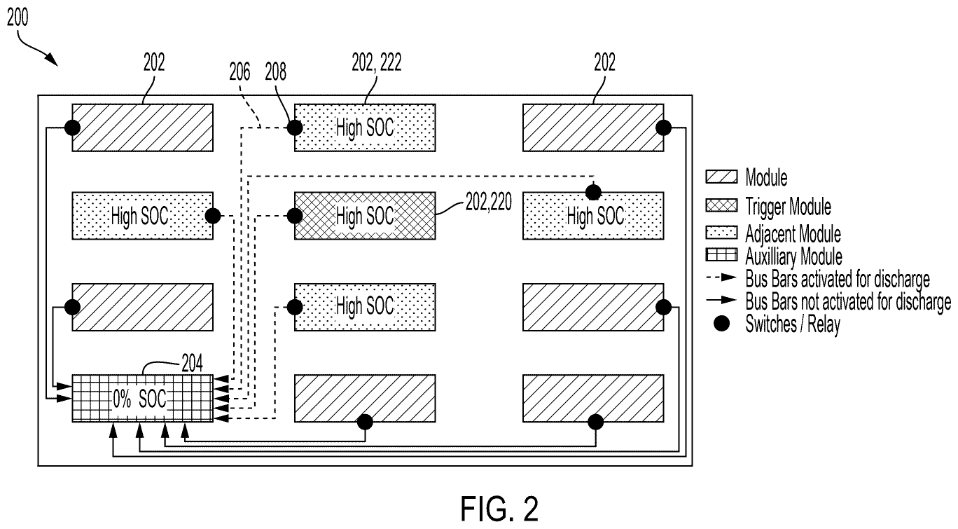

Referring now to FIG. 2 and with continued reference to FIG. 1, a schematic diagram of an example HV battery pack 200 of the HV battery system 120 according to the principles of the present application is illustrated. In the example embodiment, the HV battery pack 200 is made up of a plurality of battery modules 202, which are in turn made up a plurality of electrically connected individual battery cells (not shown) arranged in a specific topological configuration or geometrical arrangement. Each cell has a SOC denoting the electrical storage capacity that is available as a function of the rated capacity. The value of the SOC varies between 0% and 100%. A SOC of 100% indicates the cell is fully charged, whereas a SOC of 0% indicates the cell is completely discharged. As such, the HV battery pack 200 is configured to hold electric charge and deliver electric power to one or more HV components, such as the electric motor(s) 116.

In the example embodiment, the HV battery pack 200 also includes an auxiliary storage device 204 configured to receive electrical charge from one or more battery modules 202 once a thermal runaway event is detected to thereby slow propagation of the event. The auxiliary storage device 204 may be located in the HV battery pack 200 or elsewhere on the vehicle 100. In one example, the auxiliary storage device 204 is an auxiliary battery module that is the same or similar to battery module 202. In another example, the auxiliary storage device 204 is a capacitor or capacitor bank configured to store electrical energy. It will also be appreciated that HV battery pack 200 may include more than one auxiliary storage device 204.

As shown in FIG. 2, each battery module 202 is individually connected to the auxiliary storage device 204 via a bus bar 206. This enables any particular battery module 202 to directly discharge electrical energy to the auxiliary storage device 204 during a detected thermal runaway event. Each bus bar 206 includes a switch/relay 208 configured to selectively open/close to allow electrical energy to flow from the battery module 202 to the auxiliary storage device 204. In one example, the BMS 104 is configured to automatically close the particular switch/relay 208 when a thermal runaway event is detected or forecasted (e.g., via model) in the associated battery module 202. In another example, the switch/relay 208 includes a sensor, such as a temperature or gas sensor, configured to close the switch/relay 208 when a predetermined threshold is exceeded.

With continued reference to FIG. 2, an example thermal runaway event and propagation mitigation control will be described in more detail. In the example scenario, the BMS 104 detects or predicts a thermal runaway event occurring in a trigger module 220. The switch/relay 208 for trigger module 220 is subsequently closed to allow electrical charge to transfer via the dedicated bus bar 206 to the auxiliary storage device 204. This reduces the SOC of the trigger module 220 to thereby prevent or slow propagation of thermal runaway to surrounding/adjacent battery modules 222.

To provide further protection to the system, the BMS 104 is configured to open/close the switch/relay 208 for each adjacent battery module 222, which is adjacent or close to the trigger module 220 and could potentially propagate the thermal runaway if they also become too hot. In this way, electrical charge in the adjacent battery modules 222 is transferred via their dedicated bus bar 206 to the auxiliary storage device 204 to further prevent or slow propagation of thermal runaway to other battery modules 202. The electrical energy stored in the auxiliary storage device 204 may then be utilized to power additional thermal runaway mitigation measures such as, for example, running a coolant pump, HVAC unit, etc. (not shown) to reduce battery temperature or SOC or keep smoke from intruding into the vehicle cabin by pressurizing the cabin with the HVAC unit.

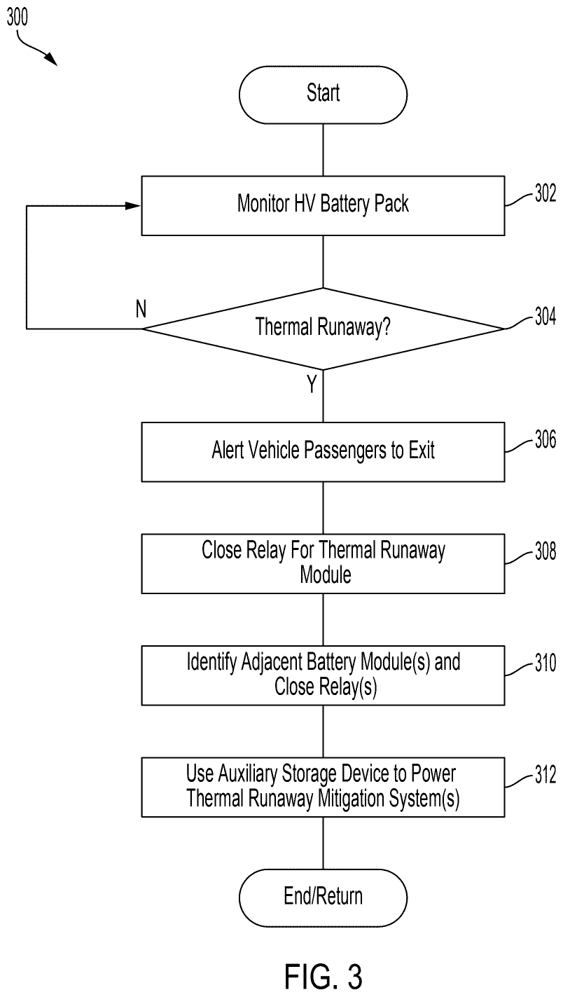

Referring now to FIG. 3, a flow diagram of an example method 300 of detecting and mitigating a thermal runaway event for a HV battery system according to the principles of the present application is illustrated. While the components of vehicle 100 are specifically referenced for illustrative/descriptive purposes, it will be appreciated that the method 300 could be applicable to any suitable electrified vehicle. The method begins at 302 where control (e.g., BMS 104, controller 136, etc.) monitors HV battery pack 200, including individual battery modules 202, for a thermal runaway event. At 304, control determines if a thermal runaway event is detected for forecasted. If no, control returns to 302. If yes, control proceeds to 306.

At 306, control alerts vehicle passengers to exit the vehicle, for example, via driver interface 140 (e.g., a vehicle display). At 308, control opens/closes the switch/relay 208 for each battery module 202 detected to be experiencing a thermal runaway event (e.g., trigger module 220) to transfer a predetermined amount of electric charge to the auxiliary storage device 204. At 310, control identifies any battery modules 202 (e.g., adjacent battery modules 222) immediately surrounding or adjacent to the trigger module 220 and opens their individual switch/relay 208 to transfer a predetermined amount of electric charge to the auxiliary storage device 204. At optional 312, control utilizes the electric charge transferred to the auxiliary storage device 204 to power additional thermal runaway mitigation systems/strategies, such as the HVAC system. Control then ends or returns to 302 for one or more additional cycles.

Described herein are systems and methods for preventing or delaying propagation of a thermal runaway event in a HV battery system. The system includes a plurality of battery modules individually and electrically connected to an auxiliary storage device maintained at 0% SOC. When a thermal runaway event is detected, switches/relays are opened/closed to allow electrical charge to transfer from the thermal runaway battery module(s) to the auxiliary storage device. This reduces the SOC of the thermal runaway module(s) to prevent or delay thermal runaway propagation. The SOC of adjacent battery modules may also be reduced and transferred to the auxiliary storage device. Advantageously, the auxiliary storage device may be a smaller battery module since it only needs to store only a portion of the charge, allowing for weight and cost savings. Additionally, the auxiliary battery module may be made of cheaper materials as it does not need to support multiple charge-discharge cycles like the regular battery modules.

It will be appreciated that the terms “controller” or “control system” or “module” as used herein refer to any suitable control device or set of multiple control devices that is/are configured to perform at least a portion of the techniques of the present application. Non-limiting examples include an application-specific integrated circuit (ASIC), one or more processors and a non-transitory memory having instructions stored thereon that, when executed by the one or more processors, cause the controller to perform a set of operations corresponding to at least a portion of the techniques of the present application. The one or more processors could be either a single processor or two or more processors operating in a parallel or distributed architecture.

It will be understood that the mixing and matching of features, elements, methodologies, systems and/or functions between various examples may be expressly contemplated herein so that one skilled in the art will appreciate from the present teachings that features, elements, systems and/or functions of one example may be incorporated into another example as appropriate, unless described otherwise above. It will also be understood that the description, including disclosed examples and drawings, is merely exemplary in nature intended for purposes of illustration only and is not intended to limit the scope of the present application, its application or uses. Thus, variations that do not depart from the gist of the present application are intended to be within the scope of the present application.

What is claimed is:

1. An electrified vehicle, comprising:
an electric traction motor;
a high voltage (HV) battery system including a HV battery pack configured to power the electric traction motor, the HV battery pack comprising:
a plurality of battery modules each configured to store electrical energy;
an auxiliary storage device electrically coupled to the battery modules; and
one or more switches/relays configured to selectively allow transfer of electrical charge from each battery module to the auxiliary storage device; and
a battery management system (BMS) including a controller programmed to:
detect a thermal runaway event of one or more of the battery modules; and
open/close the one or more switches/relays in response to detecting the thermal runaway event to thereby transfer electrical charge from the one or more battery modules experiencing the thermal runaway event to the auxiliary storage device, to thereby slow or prevent a propagation of the thermal runaway.

2. The electrified vehicle of claim 1, wherein the controller is further programmed to:
identify one or more adjacent battery modules adjacent to the one or more battery modules experiencing the thermal runaway event; and
subsequently open/close the one or more switches/relays to thereby transfer electrical charge from the one or more adjacent battery modules to the auxiliary storage device, to thereby further slow or prevent a propagation of the thermal runaway.

3. The electrified vehicle of claim 1, wherein the auxiliary storage device is maintained at 0% state of charge until detection of the thermal runaway event.

4. The electrified vehicle of claim 1, wherein the auxiliary storage device is also a battery module.

5. The electrified vehicle of claim 1, wherein the auxiliary storage device is at least one capacitor.

6. The electrified vehicle of claim 1, wherein each battery module is separately and electrically connected to the auxiliary storage device by a bus bar and one switch/relay.

7. The electrified vehicle of claim 1, wherein the one or more switches/relays are controlled by the BMS controller.

8. The electrified vehicle of claim 1, wherein the one or more switches/relays are temperature sensitive and configured to trigger based on reaching a predetermine temperature threshold.

9. The electrified vehicle of claim 1, wherein the one or more switches/relays are gas sensitive and configured to trigger based on sensing a combustion product gas.

10. The electrified vehicle of claim 1, wherein the controller is further programmed to utilize the electrical charge transferred to the auxiliary storage device to power additional components to mitigate the thermal runaway.

11. A method for mitigating a thermal runaway event of an electrified vehicle having an electric traction motor and a high voltage (HV) battery system including a battery pack that includes a plurality of battery modules, an auxiliary storage device, and one or more switches/relays configured to selectively allow transfer of electrical charge from each battery module to the auxiliary storage device, the method comprising:
detecting, by a controller, a thermal runaway event of one or more of the battery modules; and
opening/closing the one or more switches/relays in response to detecting the thermal runaway event to thereby transfer electrical charge from the one or more battery modules experiencing the thermal runaway event to the auxiliary storage device, to thereby slow or prevent a propagation of the thermal runaway.

12. The method of claim 11, further comprising:
identifying, by the controller, one or more adjacent battery modules adjacent to the one or more battery modules experiencing the thermal runaway event; and
subsequently opening/closing the one or more switches/relays to thereby transfer electrical charge from the one or more adjacent battery modules to the auxiliary storage device, to thereby further slow or prevent a propagation of the thermal runaway.

13. The method of claim 11, wherein the auxiliary storage device is maintained at 0% state of charge until detection of the thermal runaway event.

14. The method of claim 11, wherein the auxiliary storage device is also a battery module.

15. The method of claim 11, wherein the auxiliary storage device is at least one capacitor.

16. The method of claim 11, wherein each battery module is separately and electrically connected to the auxiliary storage device by a bus bar and one switch/relay.

17. The method of claim 11, wherein the one or more switches/relays are controlled by the controller.

18. The method of claim 11, wherein the one or more switches/relays are temperature sensitive and configured to trigger based on reaching a predetermine temperature threshold.

19. The method of claim 11, wherein the one or more switches/relays are gas sensitive and configured to trigger based on sensing a combustion product gas.

20. The method of claim 11, further comprising utilizing, by the controller, the electrical charge transferred to the auxiliary storage device to power additional components to mitigate the thermal runaway.
